(19) United States
(12) Patent Application Publication
(10) Pub. No.: US 2012/0152384 A1
(43) Pub. Date: Jun. 21, 2012

(54) TWO-STAGE PRESSURE REGULATOR

(76) Inventors: Paul R. Beswick, Newington, NH (US); Gary A. Treadwell, Dover, NH (US)

(21) Appl. No.: 13/391,281

(22) PCT Filed: Jun. 9, 2010
(86) PCT No.: PCT/US10/37904

§ 371 Date: Feb. 18, 2012

Related U.S. Application Data
(63) Continuation-in-part of application No. 12/796,689, filed on Jun. 9, 2010.
Application No. 12/796,689 is a continuation-in-part of application No. 11/999,941, filed on Dec. 7, 2007, now Pat. No. 8,087,428.
(60) Provisional application No. 60/873,870, filed on Dec. 7, 2006.
(60) Provisional application No. 61/238,392, filed on Aug. 31, 2009.

(51) Int. Cl. G05D 16/00

(52) U.S. Cl. 137/613

(57) ABSTRACT

Two-stage regulators for substantially reducing high pressures introduced into the regulator The reduced pressure is exerted against a first stage and second stage, each of which includes a spring-coil, plunger actuated diaphragm that urges an actuator to open a ball valve at a selected pressure to allow fluid to flow out of the regulator at a desired and much reduced pressure

### CROSS-REFERENCE TO RELATED APPLICATION

This application is a continuation-in-part of U.S. application Ser. No. 12/796,689, filed Jun. 9, 2010, for which a claim of priority is made, and claims the benefit of U.S. Provisional Application No. 61/238,392 filed Aug. 31, 2009, the contents all of which are incorporated in their entirety herein by reference.

### BACKGROUND OF THE DISCLOSURE

1. Field of the Disclosure

The disclosure relates generally to valves used to regulate fluid pressure in a system and more particularly to valves employing a diaphragm to regulate fluid pressures.

2. Statement of the Prior Art

Current miniature pressure regulating valves can only handle relatively small reductions in pressure. In addition, many such valves have problems with valve seats. It is difficult to obtain the geometries and finishes necessary to maintain a good valve seat when addressing large reductions in pressure. A further problem is the difficulty to achieve consistent, stable, demonstrable performance under varying flow and pressure conditions. A yet further problem is to achieve these results with durability and longevity. Regulators exposed to wide fluctuations in flow conditions and pressure conditions often experience component failure and relatively short operational life spans. What is described herein solves these problems by using a ball valve in conjunction with one or more diaphragms and robust coil spring based pressure adjustment assemblies to regulate pressure. The disclosure also provides an apparatus to reduce relatively high pressures to much lower pressures while regulating the pressure flow of fluids and/or gases.

### SUMMARY OF THE DISCLOSURE

In one aspect of the disclosure, a two-stage regulator uses a combination of a spring actuated ball valve and a coil spring actuated diaphragm in a first stage to reduce fluid pressure without substantially impeding fluid flow. In another aspect of the disclosure, a spring actuated ball valve and a coil spring actuated diaphragm in a second stage is combined with the first-stage valve to regulate fluid pressure in a system: again, without substantially impeding fluid flow. Each embodiment provides excellent valve seating characteristics and sustainable pressure regulation over a wide range of pressures and fluid conditions. These and other objects and features of the disclosure will be apparent from a review of the drawings and a reading of the following detailed description of the disclosure.

### BRIEF DESCRIPTION OF THE DRAWINGS

FIG. 1 is a sectional view of a two-stage diaphragm valve showing inlet and outlet ports according to one embodiment of the disclosure.

FIG. 2 is a sectional view of a two-stage regulator showing a first stage/second stage connection channel according to one embodiment of the disclosure.

FIG. 3 is a side sectional view of a two-stage regulator body showing an inlet port, an outlet port and two ball valve/diaphragm valve chambers according to one embodiment of the disclosure.

FIG. 4 is a side elevational view of a two-stage regulator body showing the outlet port and first stage/second stage connection channel (in phantom) according to one embodiment of the disclosure.

FIG. 5 is a top plan view of a two-stage regulator body showing the first stage ball valve/diaphragm valve chamber, the inlet and out let ports (in phantom), and a portion of the first stage/second stage connector channel (in phantom) according to one embodiment of the disclosure.

FIG. 5 is a side view of the inlet/piston chamber/piston sub-assembly according to one embodiment of the disclosure.

FIG. 6 is a side sectional view of a first stage/second stage adjustable cap according to one embodiment of the disclosure.

FIG. 7 is s top view of a first stage/second stage adjustable cap according to one embodiment of the disclosure.

FIG. 8 is a side sectional view of an upper plunger according to one embodiment of the disclosure.

FIG. 9 is a top view of an upper plunger according to one embodiment of the disclosure.

FIG. 10 is a side view of a coil spring cap showing a coil spring, spring cap and plunger chambers (in phantom) according to one embodiment of the disclosure.

FIG. 11 is a top view of a coil spring cap according to one embodiment of the disclosure.

FIG. 12 is a side view of a lower plunger according to one embodiment of the disclosure.

FIG. 13 is a top view of a lower plunger according to one embodiment of the disclosure.

FIG. 14 is a side sectional view of a coil spring cap subassembly according to one embodiment of the disclosure.

FIG. 15 is an exploded view of a coil spring cap subassembly according to one embodiment of the disclosure.

FIG. 16 is a first stage/second stage ball valve subassembly according to one embodiment of the disclosure.

FIG. 17 is an exploded view of a first stage/second stage ball valve subassembly according to one embodiment of the disclosure.

FIG. 18 is a side view of a first stage/second stage ball valve seat according to one embodiment of the disclosure.

FIG. 19 is a bottom view of a first stage/second stage ball valve seat according to one embodiment of the disclosure.

FIG. 20 is a side view of a first stage/second stage ball valve spring according to one embodiment of the disclosure.

FIG. 21 is a plan view of a first stage/second stage ball valve according to one embodiment of the disclosure.

FIG. 22 is a side view of a first stage/second stage spring cup according to one embodiment of the disclosure.

FIG. 23 is a top view of a first stage/second stage spring cup according to one embodiment of the disclosure.

FIG. 24a is a side view of a first stage/second stage valve adjustment screw according to one embodiment of the disclosure.

FIG. 24b is a top view of a first stage/second stage valve adjustment screw according to one embodiment of the disclosure.

FIG. 25 is a top view of a first stage/second stage diaphragm according to one embodiment of the disclosure.

FIG. 26 is a side view of a first stage/second stage diaphragm according to one embodiment of the disclosure.

FIG. 27 is a side view of a valve actuator according to one embodiment of the disclosure.

FIG. 28 is a bottom view of a valve actuator according to one embodiment of the disclosure.

### DETAILED DESCRIPTION

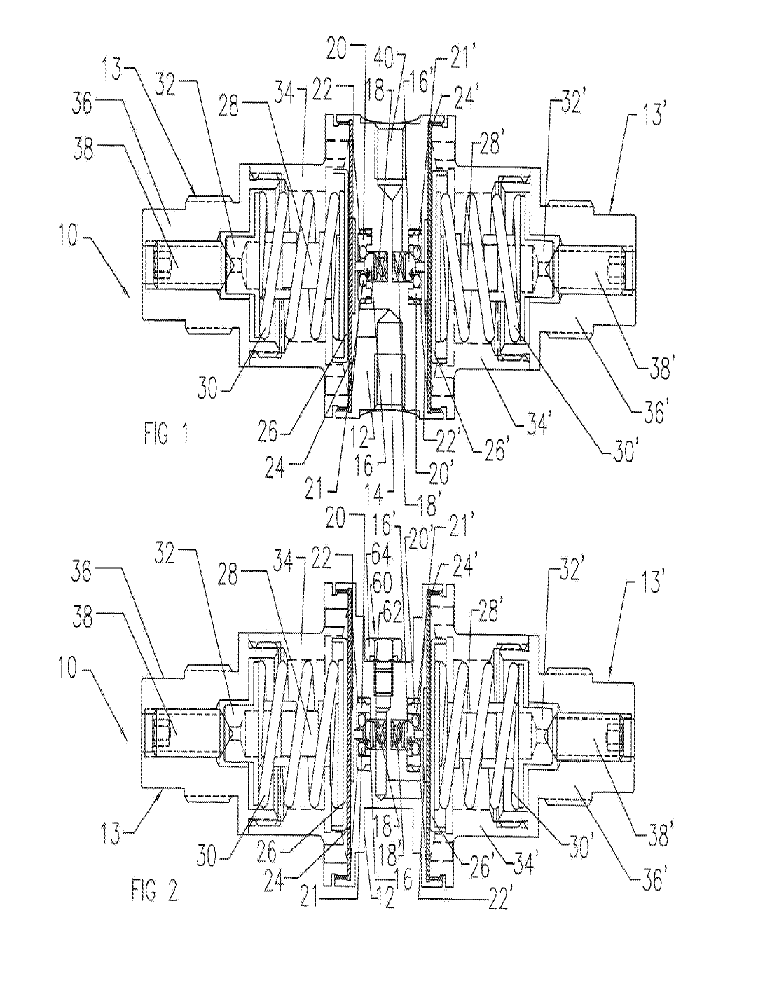

In one aspect of the disclosure, as shown in FIGS. 1 and 2, a two-stage regulator 10 combines two elastomeric diaphragm and ball valve assemblies to regulate pressure. In a first-stage valve, the regulator comprises a regulator body 12, a first-stage ball valve subassembly 15 including a first-stage ball valve 16, a first-stage ball valve spring 18, a first-stage ball valve seat 20 with a first-stage valve seat o-ring 21, a first-stage valve actuator 22, a first stage diaphragm 24, a first-stage coil spring subassembly 13 (FIG. 14), comprising a first-stage spring cup 26, a first-stage lower plunger 28, a first-stage coil spring 30, a first-stage upper plunger 32, a first-stage coil spring cap 34, a first-stage adjustment cap 36, and a first-stage adjustment screw 38_{;} all components of which are described more fully below.

A second stage valve comprises regulator body 12, a second-stage ball valve subassembly 15′ (primed numbers are used herein as reference characters to reference components substantially similar to components referenced by corresponding non-primed numbers) including a second-stage ball valve 16′, a second-stage ball valve spring 18′, a second-stage ball valve seat 20′ with second-stage valve seat o-ring 21′, a second-stage valve actuator 22′, a second-stage diaphragm 24′, a second-stage coil spring valve subassembly 13′ (FIG. 14), comprising a second-stage spring cup 26′, a second-stage lower plunger 28′, a second-stage coil spring 30′, a second-stage upper plunger 32′, a second-stage coil spring cap 34′, a second-stage adjustment cap 36′, and a second-stage adjustment screw 38′, all components of which are described more fully below.

Referring to FIGS. 3-5, regulator body 12 includes an inlet port 14 with optional threading 40 formed about at least a partial portion of the sidewall of the port for receiving and engaging threaded adapters (not shown) from pressurized fluid sources. It should be understood that other methods of securing adapters to inlet port 14 may be used, e.g., interlocking engagement features on the adapter and inlet port, friction fit, adhesives, and the like. Port 14 is in fluid communication with, and connects to, a connector port 42 that connects port 14 with a first-stage ball valve port 48 that houses first-stage ball valve subassembly 15. Subassembly port 48 includes first-stage valve seat port 50, which houses first-stage valve seat 20, and first-stage ball valve port 52, which houses first-stage ball valve 16 and first-stage ball valve spring 18. First-stage valve seat port 50 may be formed with, or provided with, first-stage seat port threading 51 to engage corresponding threading on valve seat 20.

First-stage ball valve subassembly port 48 further is connected to, and in fluid communication with, diaphragm chamber 44. Chamber 44 may include a tapered bottom 46 that 1) allows first-stage diaphragm 24 to flex downward relative to forces applied to the diaphragm via first-stage coil spring subassembly 13 and 2) provides a bottom support for diaphragm 24 to ensure protection of the diaphragm's physical and functional integrity. Chamber 44 also has portions defining an annular flat surface 45 about the perimeter of chamber 44 against which a perimeter of diaphragm 24 registers.

Fluid communication between the first stage and the second stage is provided by the combination of a first-stage/second-stage connector port 54 and a vertical connector port 56. Ports 54 and 56 are oriented in a substantially orthogonal configuration for ease of manufacture as each can be formed by boring operations from a side and a top of regulator body 12, respectively. As should be understood in the art, ports 54 and 56 may be formed as a continuous channel or fluid way during the formation of regulator body 12, if formed utilizing a molding procedure as is well known in the art.

Port 54 has portions defining a plug port 58 configured to receive a plug 60 (shown in FIG. 2). Plug port 58 may be formed with, or be provided with, port threading 59 to engage corresponding plug threading 62 on plug 60. Plug 60 may have a plug head 64 configured in a regular or irregular geometric shape to accommodate tools used to torque plug 60 into plug port 58 to provide a face seal for the port.

Connector port 56 connects to, and is in fluid communication with, first-stage diaphragm chamber 44 while first-stage/second-stage connector port 54 connects to, and is in fluid communication with second-stage ball valve subassembly port 48′ that houses second-stage ball valve subassembly 15′. Subassembly port 48′ includes second-stage valve seat port 50′, which houses second-stage valve seat 20′, and second-stage ball valve port 52′, which houses second-stage ball valve 16′ and second-stage ball valve spring 18′. Second-stage valve seat port 50′ may be formed with, or provided with, second-stage seat port threading 51′ to engage corresponding threading on valve seat 20′.

Second-stage ball valve subassembly port 48′ further is connected to, and in fluid communication with, diaphragm chamber 44′. Chamber 44′ may include a tapered bottom 46′ that 1) allows second-stage diaphragm 24′ to flex downward relative to forces applied to the diaphragm via second-stage coil spring subassembly 13′ and 2) provides a bottom support for diaphragm 24′ to ensure protection of the diaphragm's physical and functional integrity. Chamber 44′ also has portions defining a second-stage annular flat surface 45′ about the perimeter of chamber 44′ against which a perimeter of diaphragm 24′ registers.

Second-stage diaphragm chamber 44′ is connected to, and in fluid communication with, an outlet connector channel 66. Channel 66 is further connected to, and in fluid communication with, outlet port 68. Outlet port 68 may be formed with, or provided with, outlet port threading 70 used to engage corresponding threading on adapters (not shown) to deliver the reduced-pressure fluid. It should be understood that other methods of securing adapters to outlet port 68 may be used, e.g., interlocking engagement features on the adapter and outlet port, friction fit, adhesives, and the like.

Referring now to FIGS. 6. 7 and 15, a first-stage adjustment cap 36 and second-stage adjustment cap 36′ are shown. Although caps 36 and 36′ are substantially identical in construction, each will be described individually. Cap 36 includes a set screw port 72 configured and dimensioned to receive first-stage set screw 38. The sidewalls of port 74 are formed with, or provided with, screw port threading 73 to engage corresponding threading on set screw 38. A top end 74 of port 72 has portions defining an aperture dimensioned to be smaller than the diameter of set screw 38 to prevent undesirable removal of the set screw from the coil spring cap subassembly. Due to the reduced diameter, set screw 38 has to be loaded into cap 36 by backing it into position from the inside of cap 36. Screw 38 is configured to facilitate this assembly as described more fully below. The aperture of top end 74 is also sufficiently large enough to allow entry by a torquing implement to enable adjustment of the vertical position of set screw 38 in cap 36.

Set screw port 72 is connected to, and in fluid communication with, first-stage upper plunger port 76, dimensioned to receive a portion of upper plunger 32. Plunger 32 slides freely within plunger port 76. Plunger port 76 is further connected to, and in fluid communication with, a first-stage spring port 78 dimensioned to receive a first-stage upper plunger flange (described below) and first stage coil spring 30. A shoulder 80 formed in a top end of spring port 78 provides an end stop for upper plunger 32. An exterior portion of the wall defining spring port 78 may be formed with, or provided with, first-stage spring port threading 82 used to engage corresponding threading on first-stage coil spring cap 34 described more fully below.

Adjustment cap 36 is further formed with a flange 84 that provides an end stop and sealing surface for coil spring cap 34 when secured to cap 36. Cap 36 may also be formed with, or provided with, exterior threading 86 to engage regulator support surfaces such as a support panel having a threaded aperture to receive adjustment cap 36. Such an arrangement stabilizes the regulator for connection to fluid inlet and outlet sources.

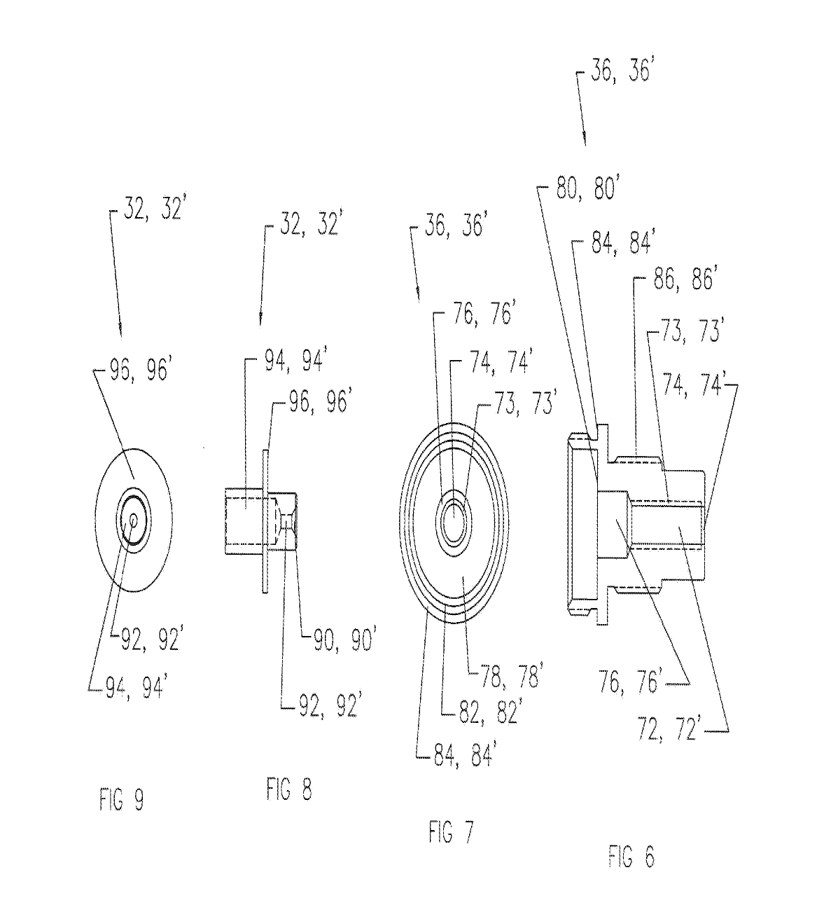

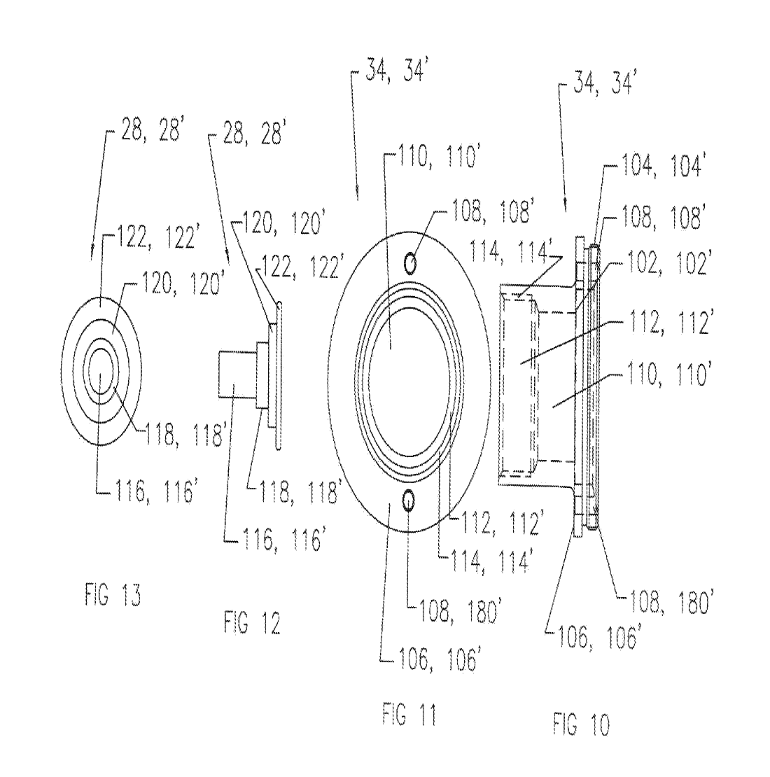

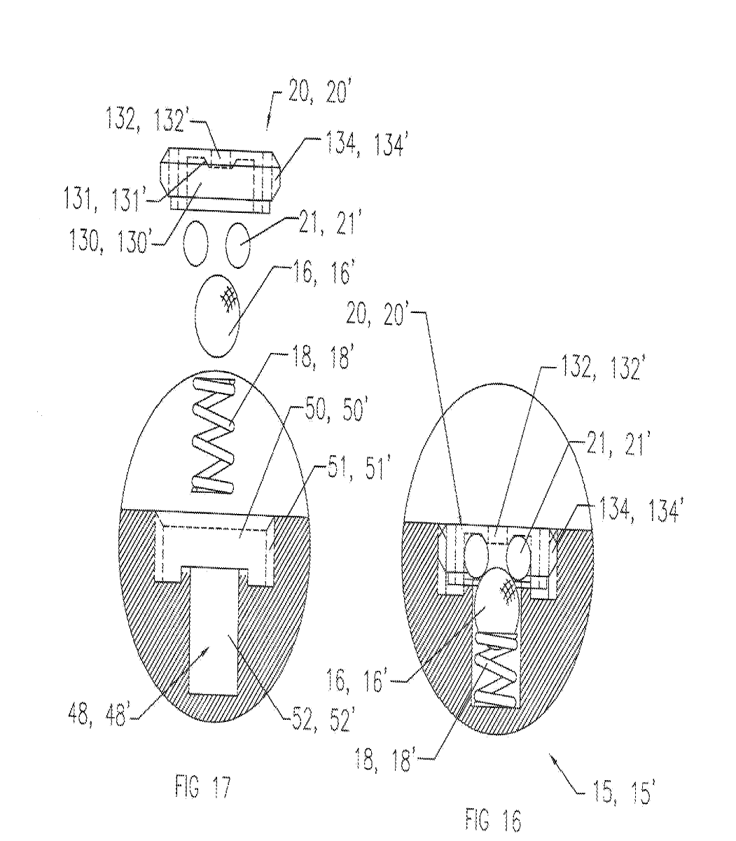

Referring now to FIGS. 8, 9 and 15, first-stage upper plunger 32 includes a set screw aperture 90 formed in a frusto-conical configuration to receive a tip of set crew 38 formed with a substantially similarly shape. The tapered surface of the tip of set screw 38 registers against the mating surface of aperture 90 to ensure proper concentric alignment of the set screw with the upper plunger throughout the plunger's range of motion within spring port 78. The configuration also maximizes the surface area in contact when force is applied to the plunger with the set screw.

A short cylindrical port 92 is formed in upper plunger 32 connected to the portions of plunger 32 defining a distal end of aperture 90. Port 92 is configured to receive the tip of set screw 38. The juncture of aperture 90 and. port 92 provides the distal most registration point between upper plunger 32 and set screw 38.

Formed in a bottom section of plunger 32 is first-stage lower plunger port 94 dimensioned to receive an upper portion of first-stage lower plunger 28. Lower plunger 28 slides freely within plunger port 94. Plunger 32 also includes an upper plunger flange 96 that performs two functions. It acts as an end stop against movement of plunger 32 in adjustment cap 36 by registering against shoulder 80 when plunger 32 is in an extreme low pressure setting. It also functions as a stop or an anchor for one end of coil spring 30 that registers against a bottom surface of flange 96.

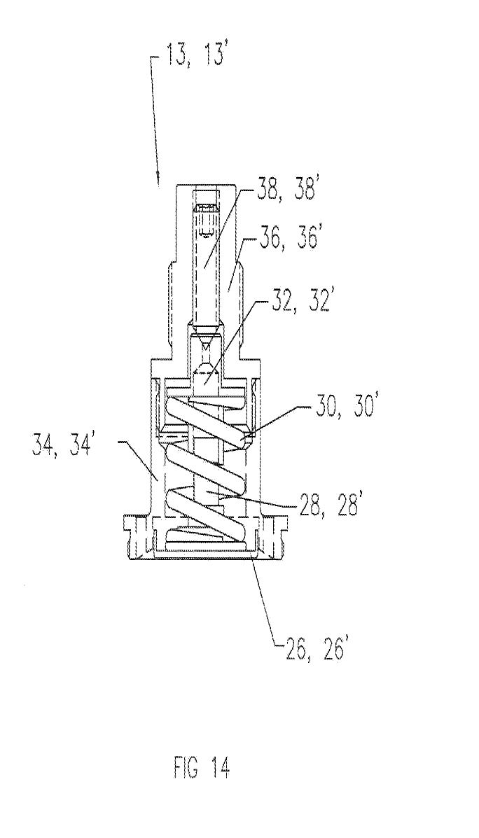

Referring now to FIGS. 10, 11 and 15, first-stage coil spring cap 34 includes surfaces to secure coil spring cap subassembly 13 (FIG. 14) to regulator body 12. Cap 34 includes a spring cup chamber 100 to house first-stage spring cup 26 a perimeter edge of which registers against internal annular shoulder 102. A lower portion of chamber 100 is formed with a tapered surface to provide a support surface for, and prevent damage to, diaphragm 24 in the event fluid enters diaphragm chamber 44 at an elevated pressure that temporarily forces diaphragm 24 upward in spring cup chamber 100, particularly when first-stage coil spring cup subassembly 13 is set at a relatively low pressure setting and a relatively high pressure fluid flows into chamber 100. Formed on, or provided about, the perimeter of the portions defining chamber 100 is cap threading 104 used to engage first-stage body cap threading 47 on body 12.

Formed about cap 34 is annular flange 106 that registers against, and forms a seal with regulator body 12. Flange 106 includes portions defining at least one coil spring cap vent bore 108. As shown in FIG. 11, two vent bores 108 are formed in flange 108 to allow the pressure in spring cup chamber 100 to be referenced against resident atmospheric pressure.

Also formed within cap 34 is substantially cylindrical coil spring chamber 110 dimensioned to receive coil spring 30. Chamber 110 is connected to, and in fluid communication with, spring cap chamber 100. The cross-sectional diameter of chamber 110 is dimensioned to allow coil spring 30 to compress and extend freely within the chamber.

Formed in a top end of cap 34 is adjustment cap bore 112 dimensioned to receive a bottom end of adjustment cap 36. Threading 114 formed, or provided on the annular wall defining bore 112 engages threading 82 of cap 34 to secure the components together and form an airtight seal.

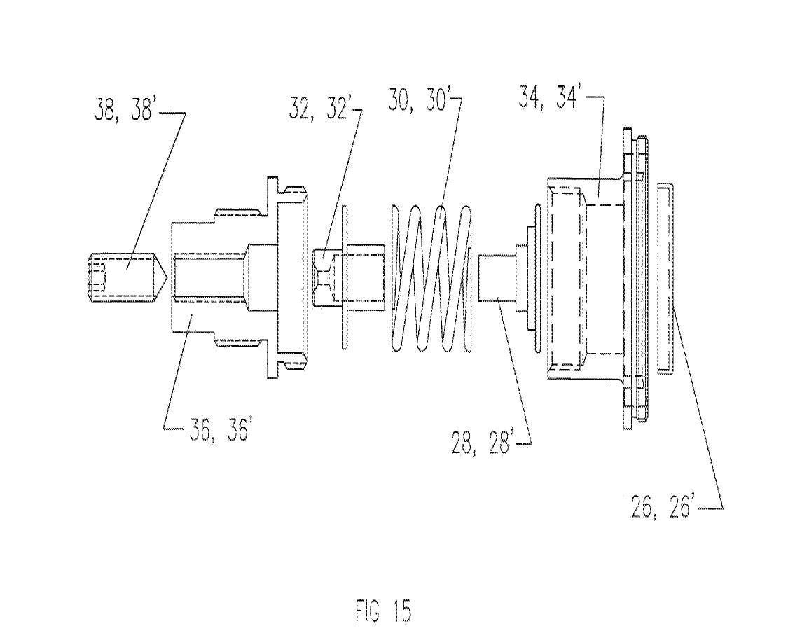

Referring now to FIGS. 12-15, first-stage lower plunger 28 has portions defining a plunger post 116 dimensioned to slide freely within plunger port 94. An annular plunger shoulder 118, formed adjacent to, and concentric with, post 116 provides an end stop for a distal end of upper plunger 32 that registers against the shoulder when applying maximum force against coil spring 30. The length of post 116 combined with the depth of plunger port 94 determines the maximum force that can be applied to coil spring 30. The force can be increased by shortening post 116, or by decreasing the depth of port 94.

A coil spring shoulder 120 is formed adjacent to, and concentric with, plunger shoulder 118. Shoulder 120 is substantially annular in shape and dimensioned to fit within the inner diameter of coil spring 30. Shoulder 120 provides a means to anchor coil spring 30 by providing a physical barrier to prevent lateral movement of spring 30 during compression and extension movements.

A plunger flange 122 is formed on a bottom end of bottom plunger 28. Flange 122 is substantially circular in shape and provides a surface against which a bottom end of coil spring 30 registers. A bottom side of flange 122 registers against spring cup 26 and transfers the force created by coil spring 30 onto the spring cup. Flange 122 is dimensioned to fit within the annular wall of cup 26.

Referring now to FIGS. 16 and 17, first-stage ball valve subassembly 15 is shown. The assembly includes first-stage ball valve 16 (shown in FIG. 21), urged against first-stage valve seat 20 via first-stage ball valve spring 18 that has a pre-loaded axial tension. To adjust the force applied, valve spring 18 may be substituted with valve springs have greater or lesser amounts of pre-loaded axial tension. Valve seat 20 includes a valve seat bore 130 dimensioned to receive a first-stage valve seat o-ring 21 positioned in bore 130. An annular channel 131 is formed on a bottom surface of bore 130 to help secure and center o-ring 21 in valve seat 20. Valve seat 20 further includes a secondary valve seat aperture 132 substantially concentric with valve seat bore 130 that provides valve actuator 22 access to ball valve 16.

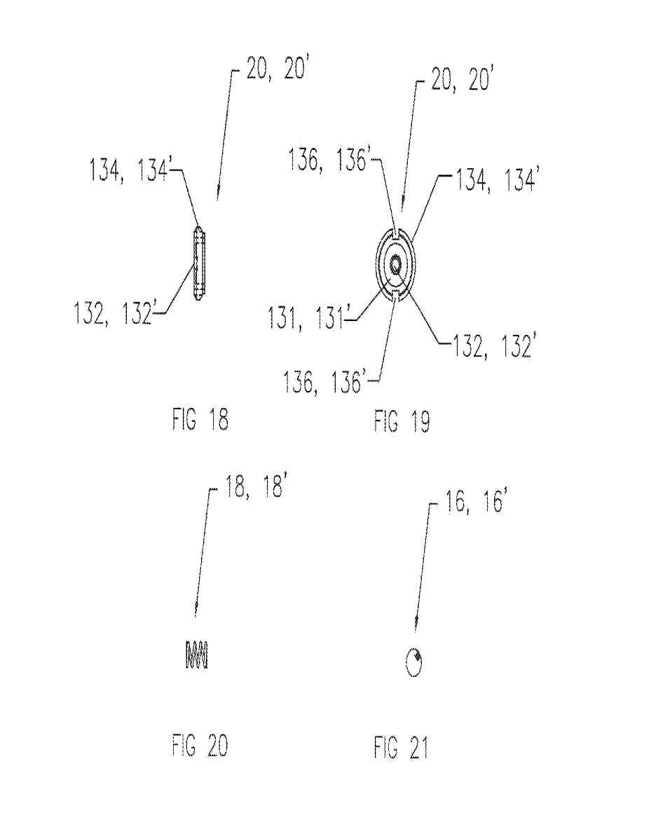

Referring now to FIGS. 18 and 19, formed on a perimeter of valve seat 20 is valve seat threading 134 configured to engage valve seat bore threading 51 formed in the annular wall of valve seat port 50. Valve seat 20 may include a pair of slots 136 (shown in FIG. 19), to receive a two-tine torque tool to torque valve seat 20 into valve seat port 50. Valve spring 18 (shown in FIG. 20) registers against ball valve 16 at a top end and against a bottom surface of ball valve port 52 at a bottom end. Valve port 52 is dimensioned to be slightly larger in diameter than ball valve 16 to allow ball valve 16 to freely move along at least part of the length of valve port 52. Spring 18 urges ball valve 16 into a sealing arrangement with o-ring 21 so as to seal off fluid communication between ball valve port 52 and valve seat bore 50, which, in turn, effectively prevents fluid communication between ball valve port 52 and diaphragm chamber 44 when incoming pressure exceeds the pre-set force of first-stage coil spring subassembly 13.

Referring to FIGS. 1, 2, 27 and 28, positioned above valve seat 20 is first-stage valve actuator 22 that includes a generally circular disk-shaped body 140 with a downwardly projecting actuator shaft 142 dimensioned to fit within secondary valve seat bore 132 so as to move freely within bore 132. Shaft 142 is dimensioned so as not to completely occlude valve seat bore 132 when urged into bore 132. A distal tip of shaft 142 registers against ball 16 and transmits pressure imparted on actuator 22 by diaphragm 24 that contacts a top surface of actuator 22.

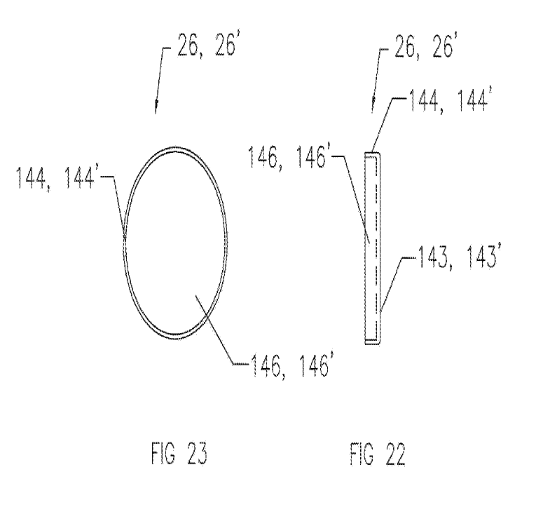

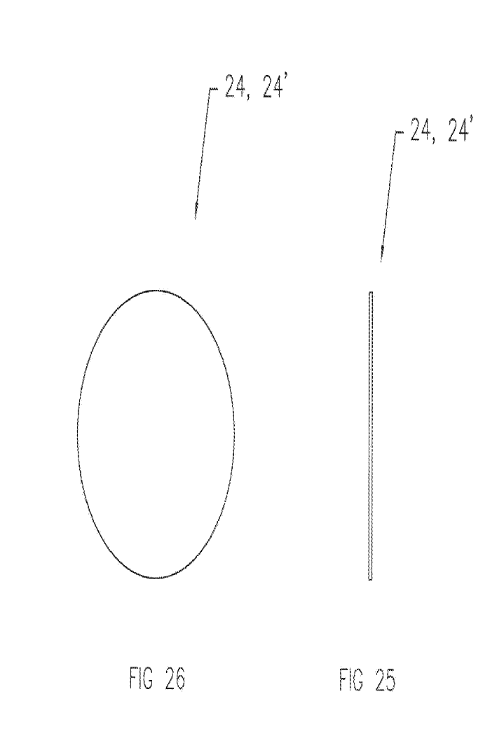

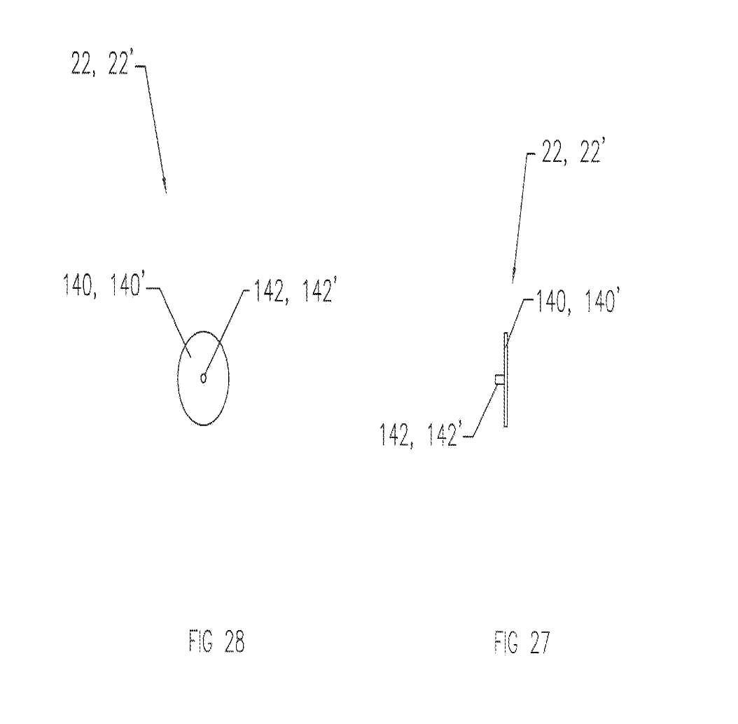

As shown in FIGS. 25 and 26, first-stage diaphragm 24 is made from an elastomeric material and is positioned in diaphragm chamber 44 so that the perimeter of the substantially circular diaphragm sits on flat portion 45. Referring to FIGS. 1, 2, 22 and 23, positioned above diaphragm 44 is spring cup 26. Spring cup 26 is generally circular in shape with a substantially flat bottom surface 143 and an annular wall 144 that defines a cup cavity 146 configured to receive and support lower plunger flange 122 as shown in FIGS. 1 and 2. Annular wall 144 of spring cup 26 is dimensioned to fit within the substantially circular spring cap chamber 100 of coil spring cap 34. The combination of spring cup 26 and chamber 100 contain lower plunger 28 in a concentric relationship with the other components of coil spring subassembly 13.

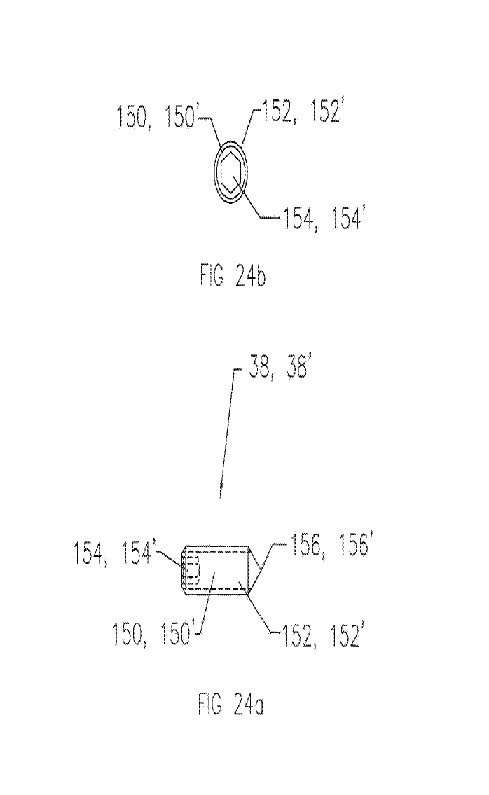

As shown in FIG. 24, set screw 38 has a main cylindrical body 150 with exterior set screw threading 152 extending substantially about the length of set screw 38. An enclosed bore 154 is formed in a top of set screw 38 to provide a means to torque the set screw with an Allen wrench or other torquing implement. A bottom end of set screw 38 may be formed so as to taper down to a point 156. This allows the tip of set screw 38 to precisely engage aperture 90 of upper plunger 32 and align the two components to occupy the same axis of symmetry.

Referring again to FIGS. 6. 7 and 15, second-stage adjustment cap 36′ are shown. Cap 36′ includes a set screw port 72′ configured and dimensioned to receive second-stage set screw 38′. The sidewalls of port 74 are formed with, or provided with, screw port threading 73′ to engage corresponding threading on set screw 38′. A top end 74′ of port 72′ has portions defining an aperture dimensioned to be smaller than the diameter of set screw 38′ to prevent undesirable removal of the set screw from the coil spring cap subassembly. Like set screw 38 with cap 36, set screw 38′ has to be loaded into cap 36′ by backing it into position from the inside of cap 36′. Screw 38′ is configured to facilitate this assembly as described more fully below. The aperture of top end 74′ is also sufficiently large enough to allow entry by a torquing implement to enable adjustment of the vertical position of set screw 38′ in cap 36′.

Set screw port 72′ is connected to, and in fluid communication with, second-stage upper plunger port 76′, dimensioned to receive a portion of upper plunger 32′. Plunger 32′ slides freely within plunger port 76′. Plunger port 76′ is further connected to, and in fluid communication with, a first-stage spring port 78′ dimensioned to receive a second-stage upper plunger flange (described below) and second-stage coil spring 30′. A shoulder 80′ formed in a top end of spring port 78′ provides an end stop for upper plunger 32′. An exterior portion of the wall defining spring port 78′ may be formed with, or provided with, second-stage spring port threading 82′ used to engage corresponding threading on second-stage coil spring cap 34′ described more fully below.

Adjustment cap 36′ is further formed with a flange 84′ that provides an end stop and sealing surface for second-stage coil spring cap 34′ when secured to cap 36′. Cap 36′ may also be formed with, or provided with, exterior threading 86′ to engage regulator support surfaces such as a support panel having a threaded aperture to receive adjustment cap 36′. Such an arrangement stabilizes the'regulator for connection to fluid inlet and outlet sources.

Referring again to FIGS. 8, 9 and 15, second-stage upper plunger 32′ includes a set screw aperture 90′ formed in a frusto-conical configuration to receive a tip of second-stage set crew 38′ formed with a substantially similarly shape. The tapered surface of the tip of set screw 38′ registers against the mating surface of aperture 90′ to ensure proper concentric alignment of the set screw with the upper plunger throughout the plunger's range of motion within spring port 78′. The configuration also maximizes the surface area in contact when force is applied to the plunger with the set screw.

A short cylindrical port 92′ is formed in upper plunger 32′ connected to the portions of plunger 32′ defining a distal end of aperture 90′. Port 92′ is configured to receive the tip of set screw 38′. The juncture of aperture 90′ and port 92′ provides the distal most registration point between upper plunger 32′ and set screw 38′.

Formed in a bottom section of plunger 32′ is second-stage lower plunger port 94′ dimensioned to receive an upper portion of second-stage lower plunger 28′. Lower plunger 28′ slides freely within plunger port 94′. Plunger 32′ also includes an upper plunger flange 96′ that performs two functions. It acts as an end stop against movement of plunger 32′ in adjustment cap 36′ by registering against shoulder 80′ when plunger 32′ is in an extreme low pressure setting. It also functions as a stop or an anchor for one end of second-stage coil spring 30′ that registers against a bottom surface of flange 96′.

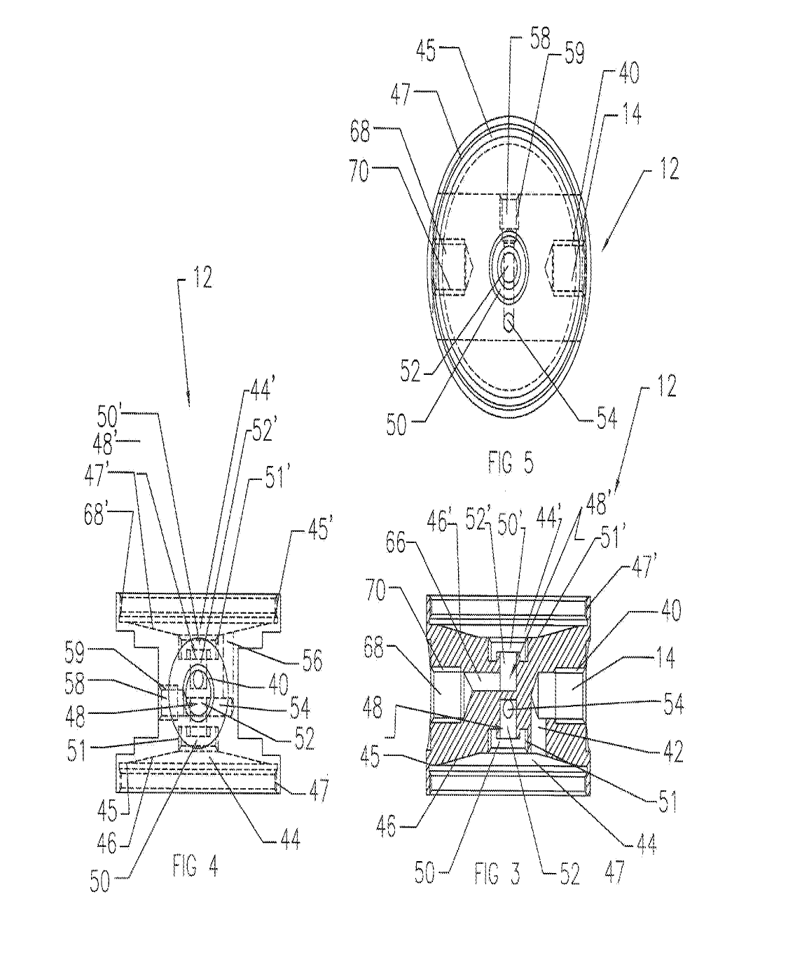

Referring again to FIGS. 10, 11 and 15, second-stage coil spring cap 34′ includes surfaces to secure second-stage coil spring cap subassembly 13′ (FIG. 14) to regulator body 12′. Cap 34′ includes a spring cup chamber 100′ to house second-stage spring cup 26′ a perimeter edge of which registers against internal annular shoulder 102′. A lower portion of chamber 100′ is formed with a tapered surface to provide a support surface for, and prevent damage to, second-stage diaphragm 24′ in the event fluid enters diaphragm chamber 44′ at an elevated pressure that temporarily forces diaphragm 24′ upward in spring cup chamber 100′, particularly when first-stage coil spring cup subassembly 13′ is set at a relatively low pressure setting and a relatively high pressure fluid flows into chamber 100′. Formed on, or provided about, the perimeter of the portions defining chamber 100′ is cap threading 104′ used to engage second-stage body cap threading 47′ (shown in FIG. 4) on body 12′.

Formed about cap 34′ is annular flange 106′ that registers . against, and forms a seal with regulator body 12′. Flange 106′ includes portions defining at least one second-stage coil spring cap vent bore 108′. As shown in FIG. 11, two vent bores 108′ are formed in flange 108′ to allow the pressure in spring cup chamber 100′ to be referenced against resident atmospheric pressure.

Also formed within cap 34′ is substantially cylindrical coil spring chamber 110′ dimensioned to receive second-stage coil spring 30′. Chamber 110 is connected to, and in fluid communication with, spring cap chamber 100′. The cross-sectional diameter of chamber 110′ is dimensioned to allow coil spring 30′ to compress and extend freely within the chamber.

Formed in a top end of cap 34′ is adjustment cap bore 112′ dimensioned to receive a bottom end of adjustment cap 36′. Threading 114′ formed, or provided on the annular wall defining bore 112′ engages threading 82′ of cap 34′ to secure the components together and form an airtight seal.

Referring again to FIGS. 12-15, second-stage lower plunger 28′ has portions defining a plunger post 116′ dimensioned to slide freely within plunger port 94′. An annular plunger shoulder 118′, formed adjacent to, and concentric with, post 116′ provides an end stop for a distal end of upper plunger 32′ that registers against the shoulder when applying maximum force against coil spring 30′. The length of post 116′ combined with the depth of plunger port 94′ determines the maximum force that can be applied to coil spring 30′. The force can be increased by shortening post 116′, or by decreasing the depth of port 94′.

A coil spring shoulder 120′ is formed adjacent to, and concentric with, plunger shoulder 118′. Shoulder 120′ is substantially annular in shape and dimensioned to fit within the inner diameter of coil spring 30′. Shoulder 120′ provides a means to anchor coil spring 30′ by providing a physical barrier to prevent lateral movement of spring 30′ during compression and extension movements.

A plunger flange 122′ is formed on a bottom end of bottom plunger 28′. Flange 122′ is substantially circular in shape and provides a surface against which a bottom end of coil spring 30′ registers. A bottom side of flange 122′ registers against spring cup 26′ and transfers the force created by coil spring 30′ onto the spring cup. Flange 122′ is dimensioned to fit within the annular wall of cup 26′.

Referring again to FIGS. 16 and 17, second-stage ball valve subassembly 15′ is shown. The assembly includes second-stage ball valve 16′ (shown in FIG. 21), urged against second-stage valve seat 20 via second-stage ball valve spring 18′ that has a pre-loaded axial tension. To adjust the force applied, valve spring 18′ may be substituted with valve springs have greater or lesser amounts of pre-loaded axial tension. Valve seat 20′ includes a valve seat bore 130′ dimensioned to receive a second-stage valve seat o-ring 21′ positioned in bore 130′. An annular channel 131′ is formed on a bottom surface of bore 130′ to help secure and center o-ring 21′ in valve seat 20′. Valve seat 20′ further includes a secondary valve seat aperture 132′ substantially concentric with valve seat bore 130′ that provides valve actuator 22′ access to ball valve 16′.

Referring again to FIGS. 18 and 19, formed on a perimeter of valve seat 20′ is valve seat threading 134′ configured to engage valve seat bore threading 51′ formed in the annular wall of valve seat port 50′. Valve seat 20′ may include a pair of slots 136′ (shown in FIG. 19), to receive a two-tine torque tool to torque valve seat 20′ into valve seat port 50′. Valve spring 18′ (shown in FIG. 20) registers against ball valve 16′ at a top end and against a bottom surface of ball valve port 52′ at a bottom end. Valve port 52′ is dimensioned to be slightly larger in diameter than ball valve 16′ to allow ball valve 16′ to freely move along at least part of the length of valve port 52′. Spring 18′ urges ball valve 16′ into a sealing arrangement with o-ring 21′ so as to seal off fluid communication between ball valve port 52′ and valve seat bore 50′, which, in turn, effectively prevents fluid communication between ball valve port 52′ and diaphragm chamber 44′ when incoming pressure exceeds the pre-set force of first-stage coil spring subassembly 13′.

Referring again to FIGS. 1, 2, 27 and 28, positioned above valve seat 20′ is second-stage valve actuator 22′ that includes a generally circular disk-shaped body 140′ with a downwardly projecting actuator shaft 142′ dimensioned to fit within secondary valve seat bore 132′ so as to move freely within bore 132′. Shaft 142′ is dimensioned so as not to completely occlude valve seat bore 132′ when urged into bore 132′. A distal tip of shaft 142′ registers against ball valve 16′ and transmits pressure imparted on actuator 22′ by second-stage diaphragm 24′ that contacts a top surface of actuator 22′.

As shown in FIGS. 25 and 26, second-stage diaphragm 24′ is made from an elastomeric material and is positioned in second-stage diaphragm chamber 44′ so that the perimeter of the substantially circular diaphragm sits on flat portion 45′. Referring to FIGS. 1, 2, 22 and 23, positioned above diaphragm 44′ is second-stage spring cup 26′. Spring cup 26′ is generally circular in shape with a substantially flat bottom surface 143′ and an annular wall 144′ that defines a cup cavity 146′ configured to receive and support second-stage lower plunger flange 122′ as shown in FIGS. 1 and 2. Annular wall 144′ of spring cup 26′ is dimensioned to fit within the substantially circular spring cap chamber 100′ of coil spring cap 34′. The combination of spring cup 26′ and chamber 100′ contain lower plunger 28′ in a concentric relationship with the other components of second-stage coil spring subassembly 13′.

As shown in FIG. 24, second-stage set screw 38′ has a main cylindrical body 150′ with exterior set screw threading 152′ extending substantially about the length of set screw 38′. An enclosed bore 154′ is formed in a top of set screw 38′ to provide a means to torque the set screw with an Allen wrench or other torquing implement. A bottom end of set screw 38′ may be formed so as to taper down to a point 156′. This allows the tip of set screw 38′ to precisely engage aperture 90′ of upper plunger 32′ and align the two components to occupy the same axis of symmetry.

Having thus described the components of Applicants novel pressure regulator, a method of operation so as to regulate and reduce relatively high pressures to much lower pressures will now be described. To operate the regulator, fluid and/or gas is introduced into inlet 14 at a pressure ranging from about 1 psi to about 1,200 psi, which is the pressure exerted on first-stage ball valve 16 exclusive of the force exerted on ball valve 16 by first-stage coil spring subassembly 13 as transmitted by first-stage diaphragm 24 and first-stage valve actuator 22.

At the initial introduction of fluid into the regulator, the kill initial pressure is exerted against ball valve 16 until the fluid has flowed through first-stage ball valve subassembly port 48. After the initial flow, the fluid pressure exerted on ball valve 16 is much reduced.

The first-stage pressure is referenced against resident atmospheric pressure due to first-stage vent bore 108. To set the first stage pressure, set screw 38 is adjusted to urge a desired pressure or force on upper plunger 32. That pressure force is transmitted onto first-stage coil spring 30, which absorbs the force by being compressed between upper plunger 32 and lower plunger 28.

The force accumulated in coil spring 30 is next exerted onto first-stage spring cup 26. The force is then transmitted to first-stage diaphragm 24, which urges valve actuator 22 against ball valve 16 so as to move ball valve 16 away from first stage valve seat 20 to allow fluid and/or gas to flow through first-stage ball valve subassembly port 48, through a lower portion of first-stage diaphragm chamber 44 at a selected substantially reduced pressure, and then through vertical connector port 56 and first-stage/second-stage connector port 54. The configuration of the first stage allows for a substantial reduction in the initial pressure of the fluid from as much as about 1,200 psi down to 100 or 200 psi, and even down to 25 psi to 50 psi, if desired.

After the initial pressure adjustment, the fluid, flowing at a pressure less than or equal to the pressure set for the first stage, continues to urge first-stage ball valve 16 away from first-stage ball valve seat 20. This allows the fluid to flow from first-stage ball valve subassembly port 48 through the lower portion of diaphragm chamber 44, through vertical connector port 56, through first-stage/second-stage connector port 54, and into second stage ball valve port 52′.

The second stage pressure is also referenced against resident atmospheric pressure due to second stage vent bore 108′. That pressure force is transmitted onto second-stage coil spring 30′, which absorbs the force by being compressed between second-stage upper plunger 32′ and second-stage lower plunger 28′. The force accumulated in coil spring 30′ is next exerted onto second-stage spring cup 26′ via lower plunger 28′. The force is then transmitted to second-stage diaphragm 24′, which urges second-stage valve actuator 22′ against second-stage ball valve 16′ so as to move ball valve 16′ away from second-stage valve seat 20′ to allow fluid and/or gas to flow through second-stage ball valve subassembly port 48′, into the lower tapered portion of second-stage diaphragm chamber 44′, into outlet connector channel 66, and through outlet port 68. The configuration of the second stage allows for a substantial reduction in the intermediate pressure of the fluid from as much as about 200 psi to 300 psi down to from about 0.5 to 1 psi. If the desired, and pre-set intermediate pressure is exceeded, second-stage ball valve 16′ migrates towards, and registers against second-stage valve seat o-ring 21′ to seal off subassembly port 48′ and prevent further travel of the fluid and/or gas into second-stage diaphragm chamber 44′.

The two-stage pressure regulator disclosed herein exhibits superior performance with respect to component durability and provides a highly precise means to reduce relatively high pressures to desired lower pressures from about 1,200 psi down to about 0.5 psi with a fluctuation in end pressure no more than about 0.15 psi.

While the present disclosure has been described in connection with one or more embodiments thereof, it will be apparent to those skilled in the art that many changes and modifications may be made without departing from the true spirit and scope of the disclosure. Accordingly, it is intended by the appended claims to cover all such changes and modifications as come within the true spirit and scope of the disclosure.

Having thus described my disclosure, what I claim as new and desire to secure by United States Letters Patent is:

1. A two-stage pressure regulator comprising:
a regulator body having portions defining a first valve chamber with a first tapered section configured to support a diaphragm in an extended condition and a second valve chamber with a second tapered section configured to support a diaphragm in an extended condition;
a first-stage valve comprising a first-stage ball valve, a first-stage diaphragm and a first-stage coil spring subassembly housed in the first valve chamber, wherein the first-stage diaphragm may be supported by the first tapered section when in an extended condition; and
a second-stage valve comprising a second-stage ball valve, a second-stage diaphragm and a second-stage coil spring subassembly housed in the second valve chamber, wherein the second-stage diaphragm may be supported by the second tapered section when in an extended condition.

2. The regulator of claim 1 wherein the first valve chamber is in fluid communication with the second valve chamber.

3. The regulator of claim 2 wherein the regulator further comprises an inlet port in fluid communication with the first valve chamber and an outlet port in fluid communication with the second valve chamber.

4. The regulator of claim 1 further comprising a first-stage body cap secured to the regulator body to enclose the first valve chamber.

5. The regulator of claim 1 further comprising a second-stage body cap secured to the regulator body to enclose the second valve chamber.

6. The regulator of claim 2 further comprising a connector port formed in the regulator body wherein the connector port is in fluid communication with the first valve chamber and the second valve chamber.

7. The regulator of claim 6 wherein the first valve chamber comprises a first-stage ball valve chamber and a first-stage diaphragm chamber wherein the ball valve and diaphragm chambers are in fluid communication.

8. The regulator of claim 7 wherein the first-stage valve further comprises a first-stage ball valve spring registered against the ball valve and a first-stage ball valve seat having an o-ring and secured to the first ball valve chamber.

9. The regulator of claim 8 wherein the first-stage valve further comprises a first-stage valve actuator having portions defining a first-stage valve actuator shaft that registers against the first-stage stage ball valve and wherein a portion of the valve actuator registers against the first-stage diaphragm.

10. The regulator of claim 9 wherein the first-stage valve further comprises a first-stage spring cup registered against the first stage diaphragm.

11. The regulator of claim 10 wherein the coil spring subassembly comprises an upper plunger having a plunger port and a flange, a lower plunger having portions defining a post and having a lower plunger flange, and a coil spring, wherein the lower plunger post is positioned within the upper plunger port and the coil spring is sandwiched between the lower plunger flange and the upper plunger flange, and wherein an end of the coil spring registers against the upper plunger flange and wherein an opposite end of the coil spring registers against the lower plunger flange.

12. The regulator of claim 11 wherein the lower plunger flange registers against the diaphragm.

13. The regulator of claim 12 wherein the first-stage coil spring subassembly further comprises a first-stage coil spring cap and a first-stage adjustment cap, wherein the coil spring cap is secured to the adjustment cap, and wherein the upper plunger, coil spring and lower plunger are housed in the combination of the coil spring cap and the adjustment cap.

14. The regulator of claim 12 wherein the first-stage coil spring subassembly further comprises a first-stage set screw secured to the adjustment cap, wherein the set screw registers against the upper plunger.

15. The regulator of claim 1 wherein the second valve chamber comprises a second-stage ball valve chamber and a second-stage diaphragm chamber wherein the ball valve and diaphragm chambers are in fluid communication.

16. The regulator of claim 15 wherein the second-stage valve further comprises a second-stage ball valve spring registered against the second-stage ball valve and a second-stage ball valve seat having an o-ring and secured to the second ball valve chamber.

17. The regulator of claim 16 wherein the second-stage valve further comprises a second-stage valve actuator having portions defining a second-stage valve actuator shaft that registers against the second-stage stage ball valve and wherein a portion of the valve actuator registers against the second-stage diaphragm.

18. The regulator of claim 17 wherein the second-stage valve further comprises a second-stage spring cup registered against the second-stage diaphragm.

19. The regulator of claim 18 wherein the second-stage coil spring subassembly comprises a second-stage upper plunger having a second-stage plunger port and a second-stage flange, a second-stage lower plunger having portions defining a second-stage post and having a second-stage lower plunger flange, and a second stage coil spring, wherein the lower plunger post is positioned within the upper plunger port and the coil spring is sandwiched between the lower plunger flange and the upper plunger flange, and wherein an end of the coil spring registers against the upper plunger flange and wherein an opposite end of the coil spring registers against the lower plunger flange.

20. The regulator of claim 19 wherein the lower plunger flange registers against the second-stage diaphragm.

21. The regulator of claim 20 wherein the second-stage coil spring subassembly further comprises a second-stage coil spring cap and a second-stage adjustment cap, wherein the coil spring cap is secured to the adjustment cap, and wherein the second-stage upper plunger, second-stage coil spring and second-stage lower plunger are housed in the combination of the coil spring cap and the adjustment cap.

22. The regulator of claim 21 wherein the second-stage coil spring subassembly further comprises a second-stage set screw secured to the second-stage adjustment cap, wherein the set screw registers against the second-stage upper plunger.
